(19) United States
(12) Patent Application Publication
(10) Pub. No.: US 2022/0317842 A1
(43) Pub. Date: Oct. 6, 2022

(54) CONTROL DEVICE, WORK MACHINE, AND CONTROL METHOD

(71) Applicant: KOMATSU LTD., Tokyo (JP)

(72) Inventors: Yoshito KUMAKURA, Tokyo (JP); Go YODA, Tokyo (JP); Kentaro TAKAYAMA, Tokyo (JP); Junki IRIE, Tokyo (JP)

(21) Appl. No.: 17/633,669

(22) PCT Filed: Sep. 30, 2020
(86) PCT No.: PCT/JP2020/037187

§ 371 Date: Feb. 8, 2022

(30) Foreign Application Priority Data
Sep. 30, 2019 (JP) 2019-179911

(51) Int. Cl. G06F 3/0485; G06F 3/0488; B60K 35/00; E02F 9/26

(52) U.S. Cl. CPC G06F 3/0485; G06F 3/0488; B60K 35/00; E02F 9/26; B60K 2370/1434; B60K 2370/61

(57) ABSTRACT

A control device of a touch panel monitor for a work machine includes a display signal generation unit configured to generate a display signal for displaying on the touch panel monitor including a plurality of display screens, a determination unit configured to receive a touch operation for each of the plurality of display screens and determine whether the received touch operation is an acceptable touch operation defined for each type of the display screens, and a control unit configured to perform a control with respect to the type of display screen according to the received touch operation when the received touch operation is the acceptable touch operation.

### CROSS-REFERENCE TO RELATED APPLICATIONS

This application is a U.S. National stage application of International Application No. PCT/JP2020/037187, filed on Sep. 30, 2020. This U.S. National stage application claims priority under 35 U.S.C. § 119(a) to Japanese Patent Application No. 2019-179911, filed in Japan on Sep. 30, 2019, the entire contents of which are hereby incorporated herein by reference.

### BACKGROUND

e. The present disclosure relates to a control device, a work machine and a control method.

### BACKGROUND INFORMATION

Japanese Unexamined Patent Application, First Publication No. 2015-202841 discloses an input control method of a touch panel monitor for a work machine capable of allowing display on a monitor screen and preventing erroneous operation input on a touch panel.

### SUMMARY

A control device attached to a driver's seat of a work machine to assist an operation of an operator by displaying a state of the work machine is known. The control device can display a plurality of types of display screens on one monitor at the same time. The types of display screens include, for example, a 3D screen, and the like, in addition to a side view displaying a state of a vehicle body of the work machine viewed from the side, a top view displaying the state of the vehicle body of the work machine viewed from above, and a front view displaying the state of the vehicle body of the work machine viewed from the front.

However, there is a need to improve the operability of such a control device.

In view of the foregoing problems, an object of the present disclosure is to improve the operability of the control device as described above.

According to one aspect of the present disclosure, a control device, which is a control device of a touch panel monitor for a work machine, includes a display signal generation unit configured to generate a display signal for display on the touch panel monitor including a plurality of display screens, a determination unit configured to receive a touch operation for each of the plurality of display screens and determine whether the received touch operation is an acceptable touch operation defined for each type of the display screen, and a control unit configured to perform control with respect to the display screen according to the received touch operation in a case where the received touch operation is the acceptable touch operation.

According to the above aspect, the operability of the control device can be improved.

### BRIEF DESCRIPTION OF DRAWINGS

FIG. 1 is a view showing an overall configuration of a work machine according to a first embodiment.

FIG. 2 is a view showing a configuration of a cab of the work machine according to the first embodiment.

FIG. 3 is a view showing a functional configuration of a control device according to the first embodiment.

FIG. 4 is a view showing a process flow of the control device according to the first embodiment.

FIG. 5 is a view showing an example of control by a control unit according to the first embodiment, in which an example of a pinch-out in a side view is shown.

FIG. 6 is a view showing an example of control by the control unit according to the first embodiment, in which an example of a pinch-out in a top view is shown.

FIG. 7 is a view showing an example of control by the control unit according to the first embodiment, in which an example of a pinch-in in a side view is shown.

FIG. 8 is a view showing an example of control by the control unit according to the first embodiment, in which an example of a rotate in a top view is shown.

FIG. 9 is a view showing an example of control by the control unit according to the first embodiment, in which an example of a one-finger swipe in a side view is shown.

FIG. 10 is a view showing an example of control by the control unit according to the first embodiment, in which an example of a one-finger swipe in a top view is shown.

FIG. 11 is a view showing an example of control by the control unit according to the first embodiment, in which an example of a simultaneous operation in side and top views is shown.

FIG. 12 is a view showing an example of control by the control unit according to the first embodiment, in which an example of a two-finger swipe on a 3D screen is shown.

FIG. 13 is a view showing an example of control by the control unit according to the first embodiment, in which an example of a one-finger swipe and a two-finger swipe on a 3D screen is described in detail.

### DESCRIPTION OF EMBODIMENTS

### First Embodiment

### (Structure of Work Machine)

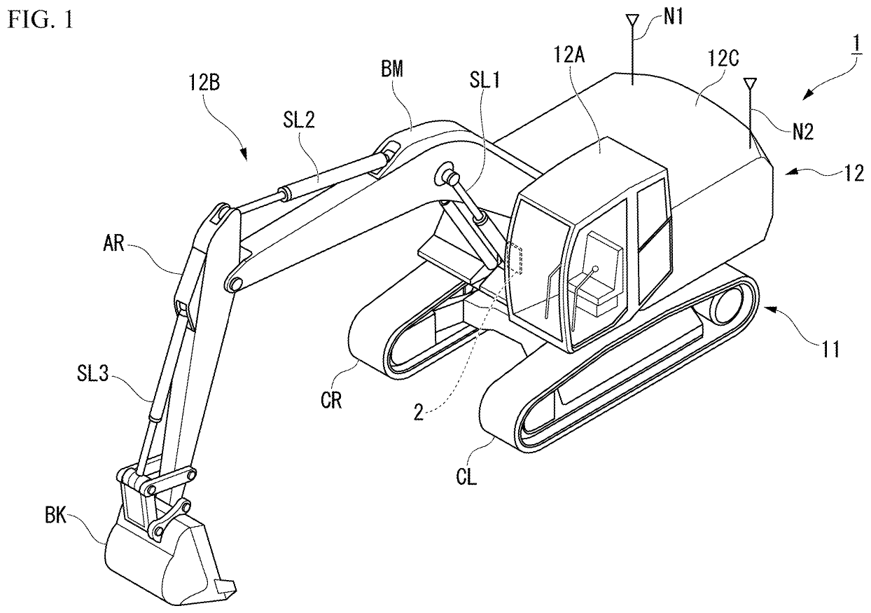

FIG. 1 is a view showing a structure of a work machine according to a first embodiment.

A work machine 1, which is a hydraulic excavator, excavates and levels the earth and the like at a work site or the like.

As shown in FIG. 1, the work machine 1, which is a hydraulic excavator, has an undercarriage 11 for traveling and an upper swing body 12 provided at an upper part of the undercarriage 11 to swing around a vertical axis. Further, the upper swing body 12 is provided with a cab 12A, work equipment 12B, and two GNSS antennas N1 and N2.

The undercarriage 11 has a left track CL and a right track CR. The work machine 1 moves forward, swings, and moves backward by the rotation of the left track CL and the right track CR.

The cab 12A is where an operator of the work machine 1 gets on board to perform operation and steering. The cab 12A is provided, for example, at a left side portion of a front end portion of the upper swing body 12. A control device 2 is mounted in the cab 12A of the work machine 1.

The work equipment 12B includes a boom BM, an arm AR, and a bucket BK. The boom BM is mounted at the front end portion of the upper swing body 12. Further, the arm AR is attached to the boom BM. Further, the bucket BK is attached to the arm AR. Further, a boom cylinder SL1 is attached between the upper swing body 12 and the boom BM. The boom BM can operate with respect to the upper swing body 12 by driving the boom cylinder SL1. An arm cylinder SL2 is attached between the boom BM and the arm AR. The arm AR can operate with respect to the boom BM by driving the arm cylinder SL2. A bucket cylinder SL3 is attached between the arm AR and the bucket BK. The bucket BK can operate with respect to the arm AR by driving the bucket cylinder SL3.

The foregoing upper swing body 12, boom BM, arm AR, and bucket BK included in the work machine 1, which is a hydraulic excavator, are an aspect of a movable part of the work machine 1.

Furthermore, the work machine 1 according to the present embodiment has been described to include the foregoing configuration, but in other embodiments, the work machine 1 does not necessarily include all of the foregoing configuration. For example, the work machine 1 according to other embodiments does not have to include the GNSS antennas N1 and N2.

### (Configuration of Cab)

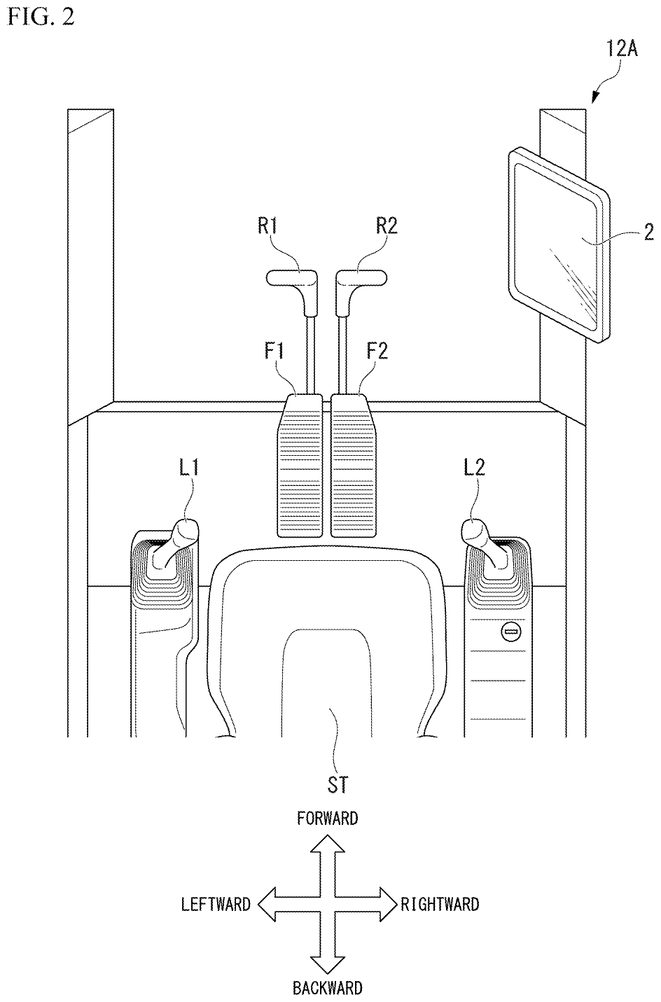

FIG. 2 is a view showing a configuration of a cab of the work machine according to the first embodiment.

As shown in FIG. 2, the cab 12A is provided with operating levers L1 and L2, foot pedals F1 and F2, and traveling levers R1 and R2.

The operating lever L1 and the operating lever L2 are disposed at left and right sides of a seat ST in the cab 12A. Further, the foot pedal F1 and the foot pedal F2 are disposed on a floor surface in front of the seat ST in the cab 12A.

The operating lever L1 disposed at the left side when facing the front of the cab is an operating mechanism for performing a swing operation of the upper swing body 12 and an excavating and dumping operation of the arm AR. Further, the operating lever L2 disposed at the right side when facing the front of the cab is an operating mechanism for performing an excavating and dumping operation of the bucket BK and a raising and lowering operation of the boom BM.

Further, the traveling levers R1 and R2 are operating mechanisms for performing an operation control of the undercarriage 11, that is, a traveling control of the work machine 1. The traveling lever R1 disposed at the left side when facing the front of the cab corresponds to a rotational drive of the left track CL of the undercarriage 11. The traveling lever R2 disposed at the right side when facing the front of the cab corresponds to a rotational drive of the right track CR of the undercarriage 11. Furthermore, the foot pedals F1 and F2 are each interlocked with the traveling levers R1 and R2 to perform the traveling control by the foot pedals F1 and F2.

The control device 2 is provided at a front right side when facing the front of the cab. Hereinafter, a function of the control device 2 will be described in detail. Furthermore, in other embodiments, the control device 2 may be provided at a front left side or the like when facing the front of the cab.

### (Functional Configuration of Control Device)

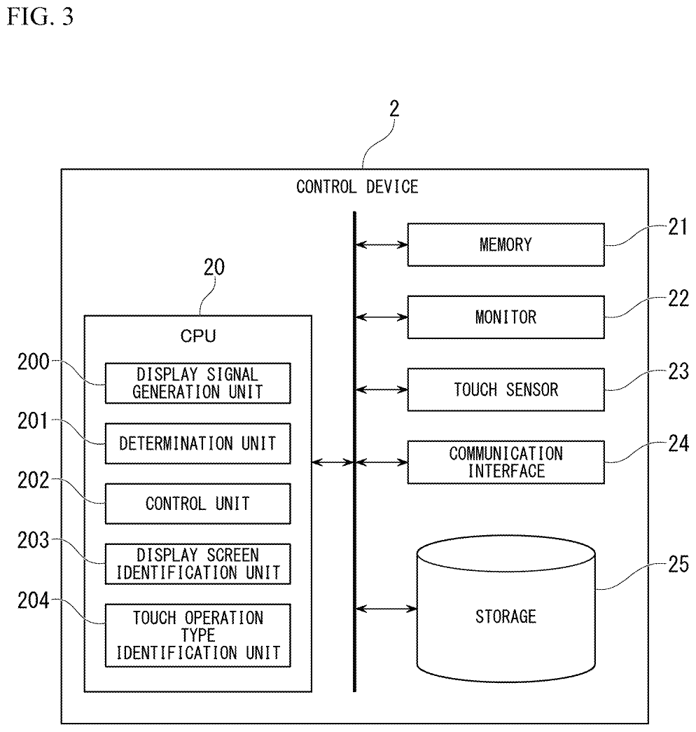

FIG. 3 is a view showing a functional configuration of a control device according to the first embodiment.

The control device 2, which is a control device of a touch panel monitor, includes a CPU 20, a memory 21, a monitor 22, a touch sensor 23, a communication interface 24, and a storage 25, as shown in FIG. 3. Furthermore, the CPU 20 may be of any aspect as long as it is similar to a FPGA, a GPU, or the like.

The CPU 20 is a processor that controls an overall operation of the control device 2. Various functions included in the CPU 20 will be described later.

The memory 21 is a so-called main storage device. Instructions and data necessary for the CPU 20 to operate based on a program are deployed in the memory 21.

The monitor 22, which is a display panel capable of visually displaying information, is, for example, a liquid crystal display, an organic EL display, or the like.

The touch sensor 23 is an input device integrally formed with the monitor 22 to specify a position of an image displayed on the monitor 22.

The communication interface 24 is a communication interface for communicating between the control device 2 and an external server.

The storage 25 is a so-called auxiliary storage device, for example, a hard disk drive (HDD), a solid state drive (SSD), or the like.

Next, the functions included in the CPU 20 will be described in detail. By operating based on a predetermined program, the CPU 20 exhibits functions as a display signal generation unit 200, a determination unit 201, a control unit 202, a display screen identification unit 203, and a touch operation type identification unit 204.

Furthermore, the predetermined program may implement some of the functions exerted by the control device 2. For example, the program may exert a function in combination with another program already stored in the storage 25, or in combination with another program mounted on another device. Furthermore, in other embodiments, the control device 2 may include a custom large-scale integrated circuit (LSI) such as a programmable logic device (PLD) in addition to or in place of the above configuration. Examples of PLDs include a programmable array logic (PAL), a generic array logic (GAL), a complex programmable logic device (CPLD), and a field-programmable gate array (FPGA). In this case, some or all of the functions implemented by the processor may be implemented by the integrated circuit.

The display signal generation unit 200 generates a display signal for displaying a plurality of display screens on one monitor 22. A state of the work machine 1 is displayed on the plurality of display screens each in a different aspect as follows. The monitor 22 displays display screens based on the signal generated by the display signal generation unit 200. The state of the work machine 1 is, for example, an operating state of the movable part of the work equipment 12B and a positional relationship between the work machine 1 and the surrounding terrain (design surface). As the state of the work machine 1 changes, the display screens are sequentially updated and changed accordingly. The operator of the work machine 1 performs the operation and steering of the work machine 1 while visually recognizing various display screens displayed on the monitor 22.

The types of display screens displayed by the display signal generation unit 200 according to the present embodiment are as follows.

(1) Side view . . . A display screen showing a state in which a vehicle body of the work machine 1 and its surrounding terrain are viewed from the side.

(2) Top view . . . A display screen showing a state in which the vehicle body of the work machine 1 and its surrounding terrain are viewed from the top.

(3) Front view . . . A display screen showing a state in which the bucket BK of the work machine 1 and its surrounding terrain are viewed from the front.

(4) 3D screen . . . A display screen that displays the vehicle body of the work machine 1 and its surrounding terrain as a three-dimensional image.

The determination unit 201 receives a touch operation for each of the plurality of display screens, and determines whether the received touch operation is an acceptable touch operation defined for each type of display screen.

Here, the types of acceptable touch operations by the control device according to the present embodiment are as follows.

(a) One-finger swipe . . . An operation of moving one finger on a surface of the monitor 22.

(b) Two-finger swipe . . . An operation of moving two fingers together on the surface of the monitor 22.

(c) Pinch-in . . . An operation of moving two fingers on the surface of the monitor 22 so as to narrow a distance between the two fingers.

(d) Pinch-out . . . An operation of moving two fingers on the surface of the monitor 22 so as to widen the distance between the two fingers.

(e) Rotate . . . An operation of rotating two fingers on the surface of the monitor 22 while keeping the distance between the two fingers constant.

Furthermore, the two-finger swipe is an example of a swipe operation based on two or more touch points. In other embodiments, any aspect may be used as long as the operation is similar to the above two-finger swipe, including a case where a touch pen or the like is used, for example. The same applies to other touch operations.

In the present embodiment, acceptable touch operations defined for each type of display screen are as follows.

(I) Acceptable touch operations on side view . . . (a) One-finger swipe, (c) Pinch-in, (d) Pinch-out

(II) Acceptable touch operations on top view . . . (a) One-finger swipe, (c) Pinch-in, (d) Pinch-out, (e) Rotate

(III) Acceptable touch operations on front view . . . (a) One-finger swipe, (c) Pinch-in, (d) Pinch-out

(IV) Acceptable touch operation on 3D screen . . . (a) One-finger swipe, (b) Two-finger swipe, (c) Pinch-in, (d) Pinch-out

A correspondence relationship between the types of display screens and the acceptable touch sensor specified as described above in (I) to (IV) is recorded in advance in, for example, the memory 21 or the storage 25.

In a case where the touch operation received in a display region of a certain display screen is an acceptable touch operation of the display screen, the control unit 202 performs control with respect to the display screen according to the received touch operation.

In the present embodiment, the control according to the touch operation is, for example, as follows.

(A) Control in a case where a one-finger swipe is received . . . An image displayed on the display screen is slidably moved. On the 3D screen, a camera position in a three-dimensional space is slidably moved on a predetermined plane.

(B) Control in a case where a two-finger swipe is received . . . In a case of being received in the 3D screen, a camera position in a three-dimensional space is rotationally moved about a predetermined point.

(C) Control in a case where a pinch-in is received . . . An image displayed on the display screen is reduced at the center of the screen.

(D) Control in a case where a pinch-out is received . . . An image displayed on the display screen is enlarged at the center of the screen.

(E) Control in a case where a rotate is received . . . An image (top view) displayed on the display screen is rotated around the center of the vehicle body.

In a case where a touch operation is received from the operator via the touch sensor 23, the display screen identification unit 203 identifies the type of display screen in the display region for which the touch operation is received.

The touch operation type identification unit 204 identifies a type of the touch operation received via the touch sensor 23.

(Process Flow of Control Device)

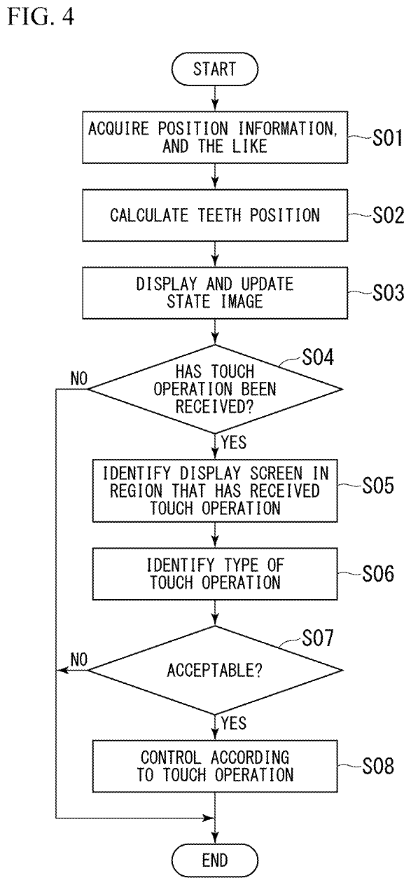

FIG. 4 is a view showing a process flow of the control device according to the first embodiment.

The process flow shown in FIG. 4 is executed after power is applied to the control device 2 by the operator. Furthermore, the control device 2 may be automatically started when the power of the work machine 1 is applied thereto.

First, the CPU 20 acquires information indicating a position of the work machine 1 via the GNSS antennas N1 and N2, the communication interface 24, and the like (step S01). Here, the information indicating the position of the work machine 1 is three-dimensional coordinate information indicated in a global coordinate system. Further, the CPU 20 calculates an azimuth direction of the swing body of the work machine 1 based on the acquired positions of the GNSS antenna N1 and the GNSS antenna N2.

Furthermore, a design surface, which is terrain data acquired as three-dimensional data, is recorded in advance in the storage 25 of the control device 2. The CPU 20 displays the surrounding terrain on each display screen based on the terrain data and the positioning information of the work machine 1 based on the GNSS antennas N1 and N2.

Next, the CPU 20 calculates a teeth position of the bucket BK (step S02). Here, the CPU 20 calculates an operating state of each movable part of the work equipment 12B, that is, an angle of the boom BM with respect to the upper swing body 12, an angle of the arm AR with respect to the boom BM, and an angle of the bucket BK with respect to the arm AR through a sensor attached to each of the cylinders SL1, SL2, SL3, or an angle sensor, such as an IMU.

Furthermore, the shape, connection position, size, and the like of each movable part of the work equipment 12B are recorded in advance in the storage 25. The shape, connection position, size, and the like of each movable part of the work equipment 12B are also described below with specification information. The CPU 20 combines this specification information in addition to the calculation result of the operating state of each movable part and the terrain data to calculate a distance from the teeth of the bucket BK to the design surface. Furthermore, in other embodiments, the distance may be a distance from a portion other than the teeth of the bucket BK to the design surface.

Next, the CPU 20 displays and updates each display screen based on position information acquired in step S01 and the calculation result of the operating states of the movable parts of the work equipment 12B performed in step S02 (step S03). Accordingly, an actual operating state of the work machine 1 is reflected on each display screen.

Next, the CPU 20 determines whether the touch operation has been received from the operator (step S04). In a case where the touch operation is not received from the operator (step S04; NO), the CPU 20 ends the process flow without performing any particular process, and starts a new process flow from the foregoing step S01.

On the other hand, in a case where the touch operation is received from the operator (step S04; YES), the CPU 20 performs the following process.

The display screen identification unit 203 of the CPU 20 identifies the type of the display screen at a position where the touch operation is received (step S05). Specifically, the display screen identification unit 203 acquires touch coordinates indicating the position on the monitor 22 that senses the touch via the touch sensor 23. Then, the display screen identification unit 203 identifies a display screen among the foregoing display screens (1) to (4) where the touch coordinates belong to a display region of said display screen. A specific process of the display screen identification unit 203 is as follows. First, in a case where a position of the touch is identified by the display screen identification unit 203, the display screen identification unit 203 acquires coordinate information (X, Y) indicating the position. At a time point of acquiring the coordinate information (X, Y), the display screen identification unit 203 acquires which display screen is displayed at which position on the monitor 22 at that time point. Then, the display screen identification unit 203 identifies whether the display screen in which the display screen is displayed with the acquired coordinate information (X, Y) is a side view, a top view, a front view, or a 3D screen, or any other screen. In this way, the display screen identification unit 203 identifies the display screen displayed on the monitor 22 at the present time point at the touched position.

Next, the touch operation type identification unit 204 of the CPU 20 identifies the type of touch operation received via the touch sensor 23 (step S06). Specifically, the touch operation type identification unit 204 traces the number and movements of touch positions received from the operator to determine which of the foregoing (a) to (e) the type of the touch operation corresponds to.

For example, in a case where the touch sensor 23 senses the coordinates of at least one point on a surface on the monitor 22 and senses that the sensed coordinates move in a predetermined direction, it may be determined as a one-finger swipe.

Further, for example, in a case where the touch sensor 23 senses the coordinates of at least two points on the surface on the monitor 22, and senses that the sensed coordinates of at least two points move in the same predetermined direction, it may be determined as a two-finger swipe.

Further, for example, in a case where the touch sensor 23 senses the coordinates of at least two points on the surface on the monitor 22, and senses that the sensed coordinates of at least two points move in directions closer to each other, it may be determined as a pinch-in.

Further, for example, in a case where the touch sensor 23 senses the coordinates of at least two points on the surface on the monitor 22, and senses that the sensed coordinates of at least two points move in directions away from each other, it may be determined as a pinch-out.

Further, for example, in a case where the touch sensor 23 senses the coordinates of at least two or more points on the surface on the monitor 22, and senses that the sensed coordinates of at least two points move in a direction of rotation while keeping the distance at a predetermined value, it may be determined as a rotate.

Furthermore, in a case where there are a plurality of sensed coordinates and the plurality of coordinates are close to one another, the coordinates may be determined as one point.

Furthermore, the operations using fingers have been described above, but in other embodiments, they may be operated and sensed by other means for sensing the touch panel monitor, such as a touch pen. Further, the method of determination in the foregoing (a) to (e) is not limited to the above-described aspect, and the determination may be performed in another commonly used aspect.

Next, the determination unit 201 of the CPU 20 determines whether the type of touch operation received in step S04 is an acceptable touch operation defined for each type of display screen (step S07). Specifically, the determination unit 201 determines whether the type of touch operation identified in step S06 corresponds to an acceptable touch operation defined for the type of display screen identified in step S05 with reference to the corresponding information specified in the foregoing (I) to (IV).

In a case where the type of touch operation received in step S04 is not an acceptable touch operation defined for each type of display screen (step S07; NO), the CPU 20 ends the process flow without performing any particular process, and starts a new process flow from the foregoing step S01.

On the other hand, in a case where the type of touch operation received in step S04 is an acceptable touch operation defined for each type of display screen (step S07; YES), the CPU 20 of the control unit 202 controls the display screen that has received the touch operation according to the received touch operation (step S08). Specifically, the control unit 202 reflects the control according to the type of touch operation defined as described above in (A) to (E) on one display screen that has received the touch operation.

Furthermore, steps S01 and S02 in the process flow described with reference to FIG. 4 are not essential components of the control device 2, and such steps may not be included in other embodiments.

(Example of Control by Control Unit)

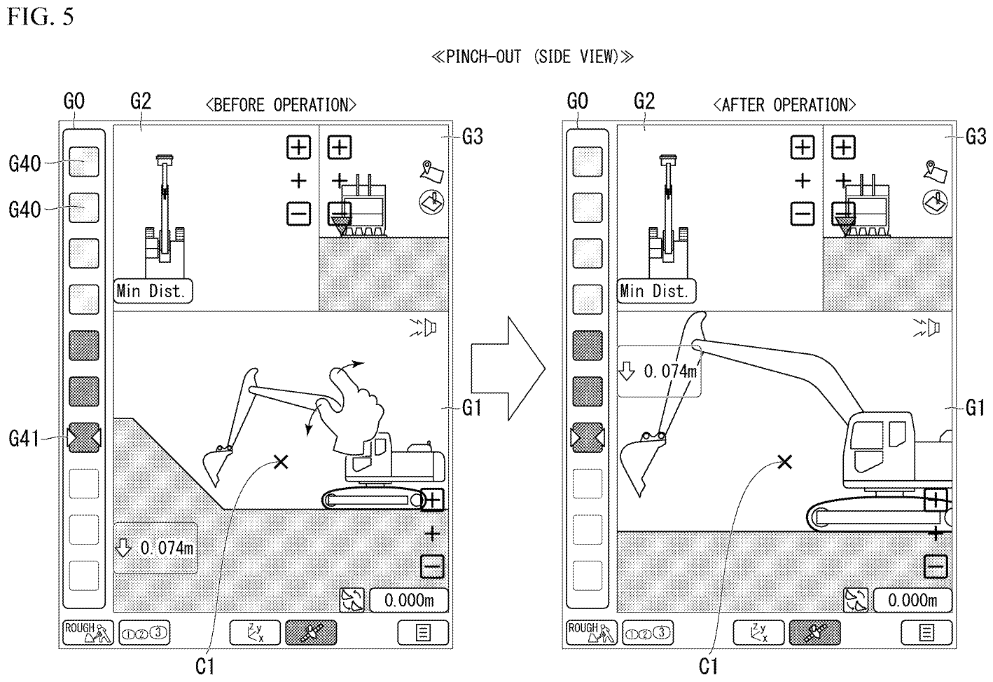

FIGS. 5 to 13 are views showing an example of control by the control unit according to the first embodiment.

Hereinafter, the control content of the control unit 202 will be described in detail with reference to FIGS. 5 to 13.

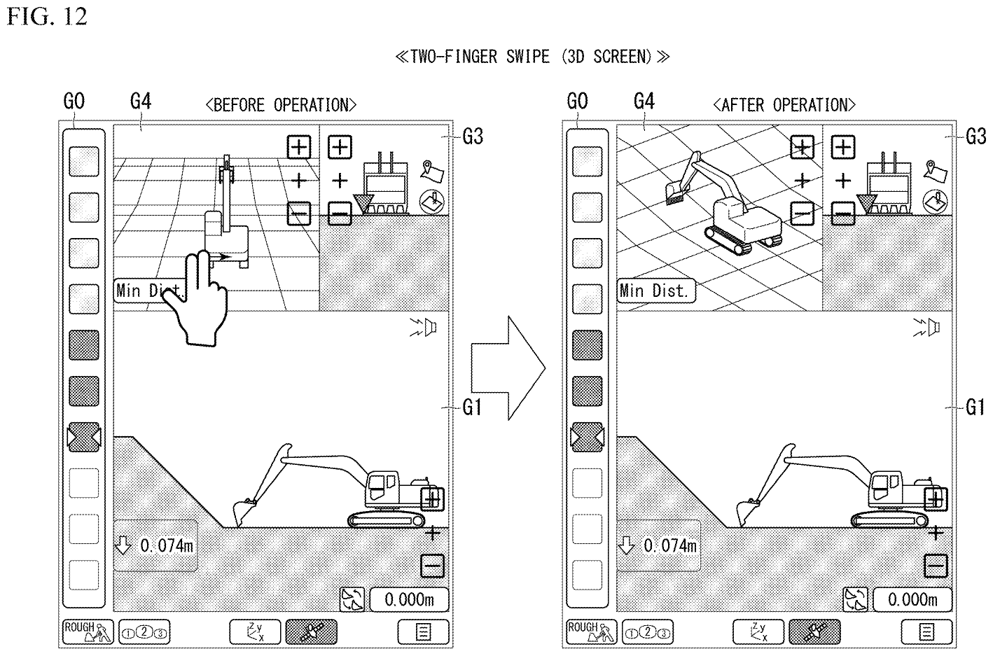

First, an example of an initial state of an image displayed on the monitor 22 will be described. As shown in FIGS. 5 to 13, information displayed on the monitor 22 includes a guidance image G0 and three display screens. A side view G1, a top view G2, a front view G3, and a 3D screen G4 (see FIG. 12) can be displayed on the three display screens according to selection by the operator.

The side view G1, the top view G2, the front view G3, and the 3D screen G4, which are all views showing a current operating state of the work machine 1, for example, the postures of the boom BM, the arm AR, and the bucket BK constituting the work equipment 12B, and a positional relationship with the surrounding terrain, and show states seen from different viewpoints.

The guidance image G0 will be described in brief with reference to FIG. 5.

The guidance image G0 is a view schematically showing a distance between the teeth of the bucket BK and a design surface.

As shown in FIG. 5, the guidance image G0 is configured with a plurality of index images G40 arranged in a vertical direction. The index images G40 are displayed in color or colorless, and the lowermost index image G40 among the colored index images G40 corresponds to a teeth position of the bucket BK.

The index image G40 attached with a reference position image G41 corresponds to the design surface. The index images G40 above the index image G40 attached with the reference position image G41 correspond to positions higher than the design surface. Further, the index images G40 below the index image G40 attached with the reference position image G41 correspond to positions lower than the design surface.

A distance between the lowermost one of the colored index images G40 and the index image G40 attached with the reference position image G41 corresponds to a distance between the teeth of the bucket BK and the design surface. That is, the index image G40 to be displayed in color is determined based on the above-described calculation result of the distance between the teeth of the bucket BK and the design surface.

In a case where the teeth of the bucket BK are positioned below the design surface, the index image G40 below the index image G40 attached with the reference position image G41 is displayed in color.

The color of the index image G40 when displayed in color is different according to the distance between the teeth of the bucket BK and the design surface.

### (Pinch-Out (Side View))

FIG. 5 shows an example of control in a case where a pinch-out operation is received in a display region of the side view G1. As shown in <Before operation> of FIG. 5, it is assumed that the operator performs a touch operation of pinch-out in the display region of the side view G1. In this case, as shown in <After operation> of FIG. 5, the control unit 202 enlarges a display image of the side view G1 that has received the touch operation with respect to a screen center C1 of the side view G1.

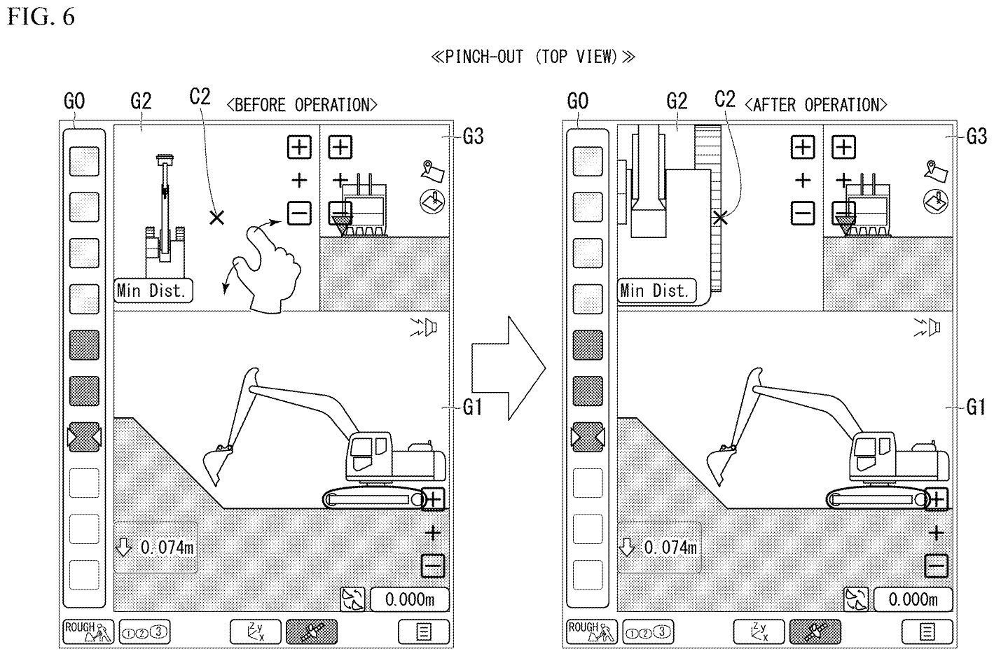

Furthermore, a hand shown in the drawing schematically represents the movement of the operator's own hand and fingers performing the touch operation, and is not an image displayed on the actual display screen. The same applies to FIGS. 6 to 12 below. Further, marks indicating the screen center C1, a screen center C2, and a work machine center C2′ shown in the drawings of FIGS. 5, 6, 7, 8, and 11 are positions on the display screen for explanation, and are not images displayed on the actual display screen.

Furthermore, in this case, the control unit 202 does not perform any control with respect to the display regions of the guidance image G0, the top view G2, and the front view G3.

(Pinch-Out (Top View))

FIG. 6 shows an example of control in a case where a pinch-out operation is received in a display region of the top view G2. As shown in <Before operation> of FIG. 6, it is assumed that the operator performs a touch operation of pinch-out in the display region of the top view G2. In this case, as shown in <After operation> of FIG. 6, the control unit 202 enlarges a display image of the top view G2 that has received the touch operation with respect to the screen center C2 of the top view G2.

Furthermore, in this case, the control unit 202 does not perform any control with respect to the display regions of the guidance image G0, the side view G1 and the front view G3.

(Pinch-In (Side View))

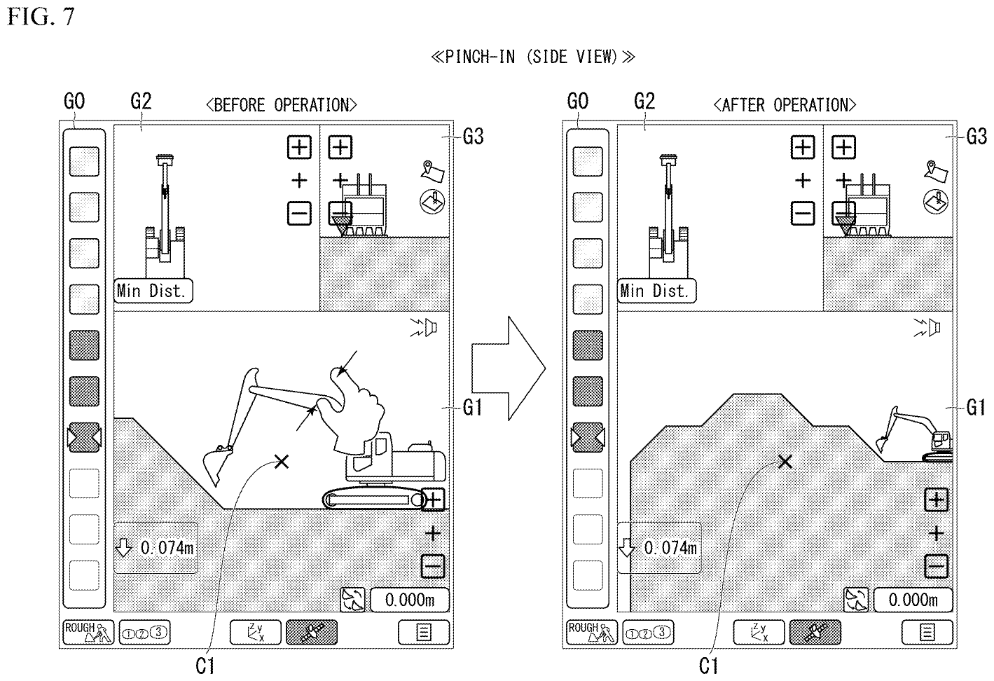

FIG. 7 shows an example of control in a case where a pinch-in operation is received in a display region of the side view G1. As shown in <Before operation> of FIG. 7, it is assumed that the operator performs a touch operation of pinch-in in the display region of the side view G1. In this case, as shown in <After operation> of FIG. 7, the control unit 202 reduces a display image of the side view G1 that has received the touch operation with respect to the screen center C1 of the side view G1.

Furthermore, in this case, the control unit 202 does not perform any control with respect to the display regions of the guidance image G0, the top view G2, and the front view G3.

(Rotate (Top View))

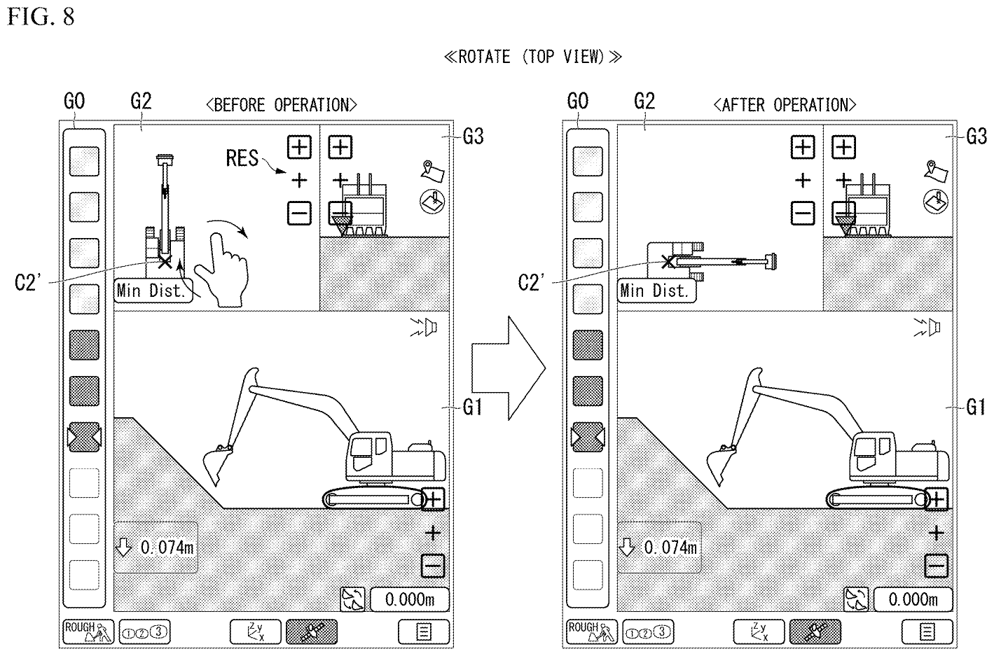

FIG. 8 shows an example of control in a case where a rotation operation is received in a display region of the top view G2. As shown in <Before operation> of FIG. 8, it is assumed that the operator performs a touch operation of rotate in the display region of the top view G2. In this case, as shown in <After operation> of FIG. 8, the control unit 202 rotates a display image of the top view G2 that has received the touch operation with respect to the center of the vehicle body, that is, the work machine center CT in the top view G2. Furthermore, the display image of the top view G2 rotates with respect to the work machine center C2′ regardless of on which region of the top view G2 the touch operation of rotate is performed.

Furthermore, in this case, the control unit 202 does not perform any control with respect to the display regions of the guidance image G0, the side view G1 and the front view G3.

Further, for example, in a case where a touch operation of a reset button RES superimposed and displayed on the top view G2 of FIG. 8 is received, the control unit 202 may perform control to return a display state of the top view G2 to a state before the touch operation of rotate.

(One-Finger Swipe (Side View))

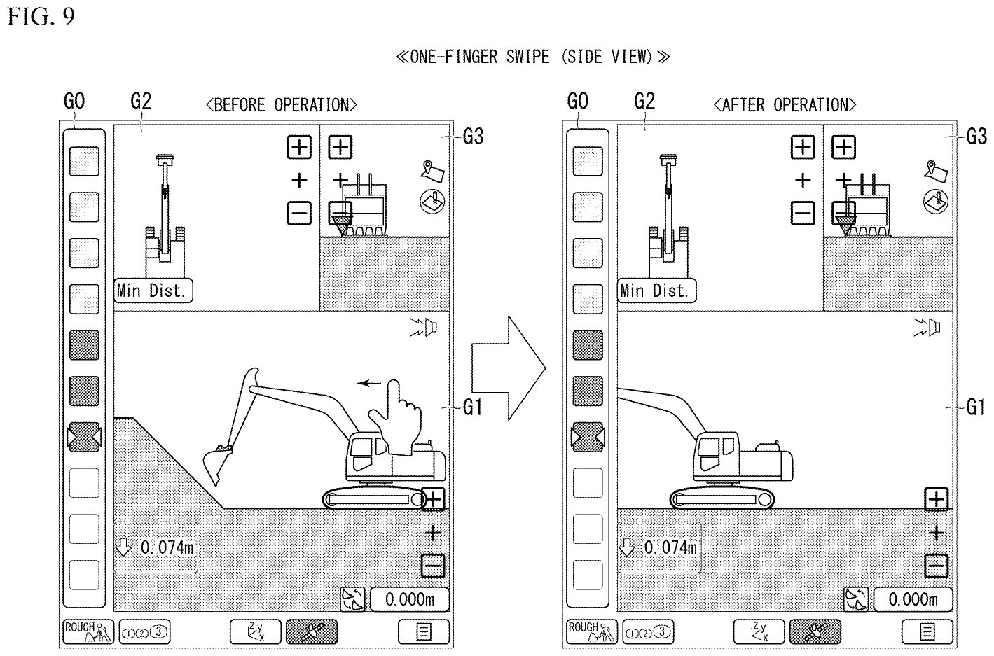

FIG. 9 shows an example of control in a case where a one-finger swipe operation is received in a display region of the side view G1. As shown in <Before operation> of FIG. 9, it is assumed that the operator performs a touch operation of one-finger swipe in the display region of the side view G1. In this case, as shown in <After operation> of FIG. 9, the control unit 202 slidably moves a display image of the side view G1 that has received the touch operation.

Furthermore, in this case, the control unit 202 does not perform any control with respect to the display regions of the guidance image G0, the top view G2, and the front view G3.

(One-Finger Swipe (Top View))

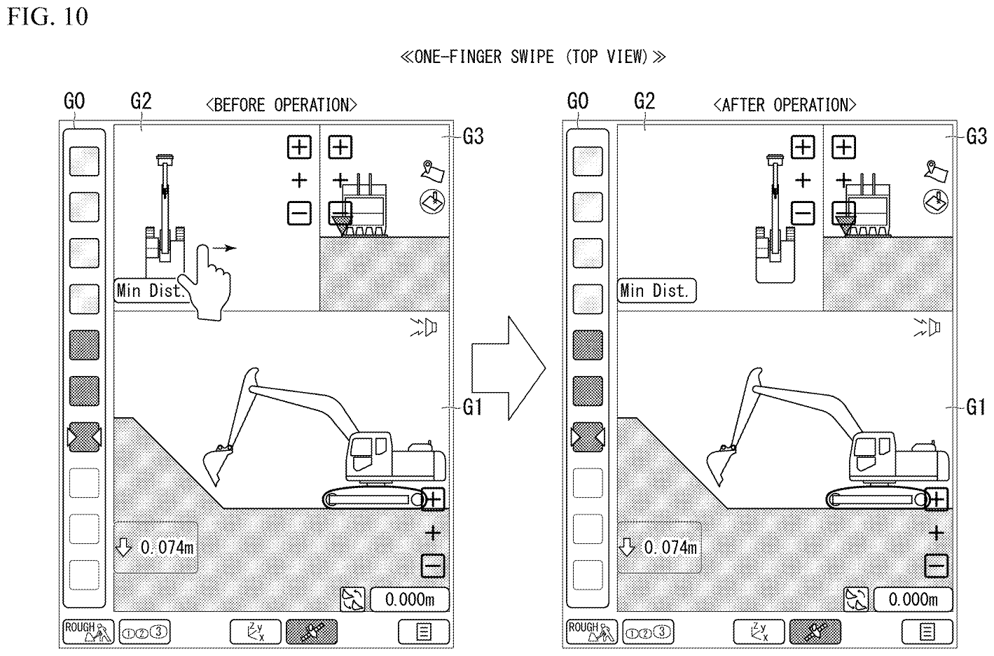

FIG. 10 shows an example of control in a case where a one-finger swipe operation is received in a display region of the top view G2. As shown in <Before operation> of FIG. 10, it is assumed that the operator performs a touch operation of one-finger swipe in the display region of the top view G2. In this case, as shown in <After operation> of FIG. 10, the control unit 202 slidably moves a display image of the top view G2 that has received the touch operation.

Furthermore, in this case, the control unit 202 does not perform any control with respect to the display regions of the guidance image G0, the side view G1 and the front view G3.

(Example of Simultaneous Operation)

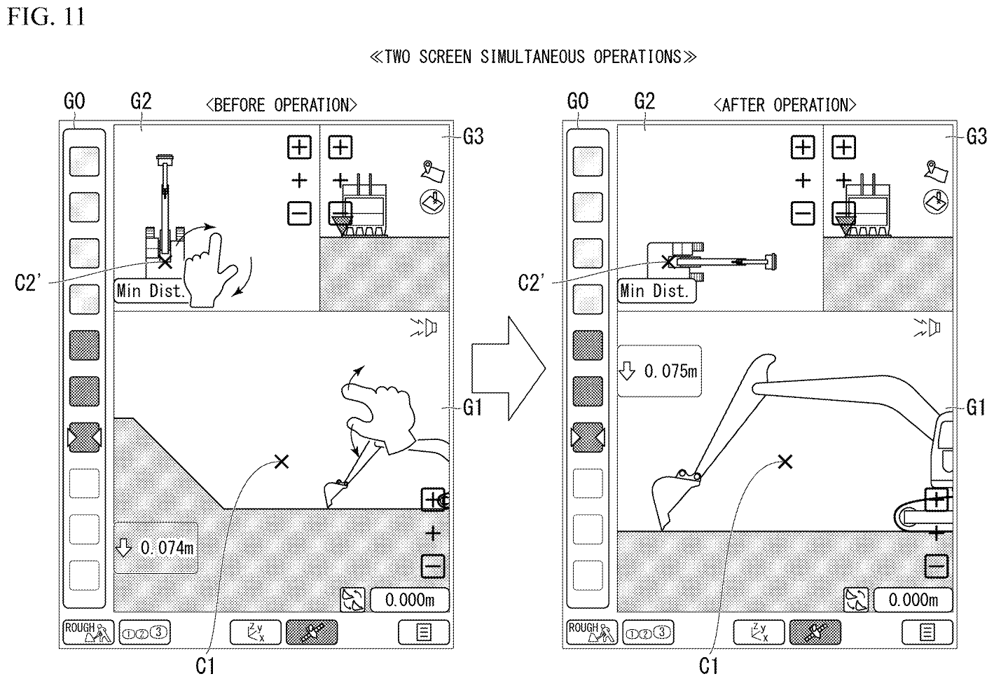

FIG. 11 shows an example of control in a case where a pinch-out operation is received in a display region of the side view G1, and at the same time, a rotation operation is received in a display region of the top view G2. As shown in <Before operation> of FIG. 11, it is assumed that the operator performs a touch operation of pinch-out in the display region of the side view G1, and at the same time, performs a touch operation of rotate in the display region of the top view G2. In this case, as shown in <After operation> of FIG. 11, the control unit 202 enlarges the display image of the side view G1 that has received the touch operation of pinch-out with respect to the screen center C1, and at the same time, rotates the display image of the top view G2 that has received the touch operation of rotate with respect to the work machine center CT.

In this way, in a case where touch operations are simultaneously received on each of the plurality of display screens, the control unit 202 simultaneously performs control with respect to each of the display screens that have received the touch operations according to each touch operation.

Furthermore, a combination of display screens that perform simultaneous touch operations and a combination of types of touch operations are not limited to the example of FIG. 11, and any combination can be received. For example, while any one of one-finger swipe, pinch-in, and pinch-out operations is received on the side view G1, any one of one-finger swipe, pinch-in, and pinch-out operations can be received on the front view G3. Similarly, while any one of one-finger swipe, pinch-in, pinch-out, and rotation operations is received on the top view G2, any one of one-finger swipe, pinch-in, and pinch-out operations can also be received on the front view G3. Moreover, for example, while any one of one-finger swipe, pinch-in, and pinch-out operations is received on the side view G1, any one of one-finger swipe, two-finger swipe, pinch-in, and pinch-out operations can also be received on the 3D screen G4 to be described later.

(Two-Finger Swipe (3D Screen))

FIG. 12 shows an example of control in a case where a two-finger swipe operation is received in a display region of the 3D screen G4. As shown in <Before operation> of FIG. 12, it is assumed that the operator performs a touch operation of two-finger swipe in the display region of the 3D screen G4. In this case, as shown in <After operation> of FIG. 12, the control unit 202 rotationally moves a camera position in a three-dimensional space of a camera that projects the 3D screen G4 that has received the touch operation, about a predetermined point.

Furthermore, in this case, the control unit 202 does not perform any control with respect to the display regions of the guidance image G0, the side view G1 and the front view G3.

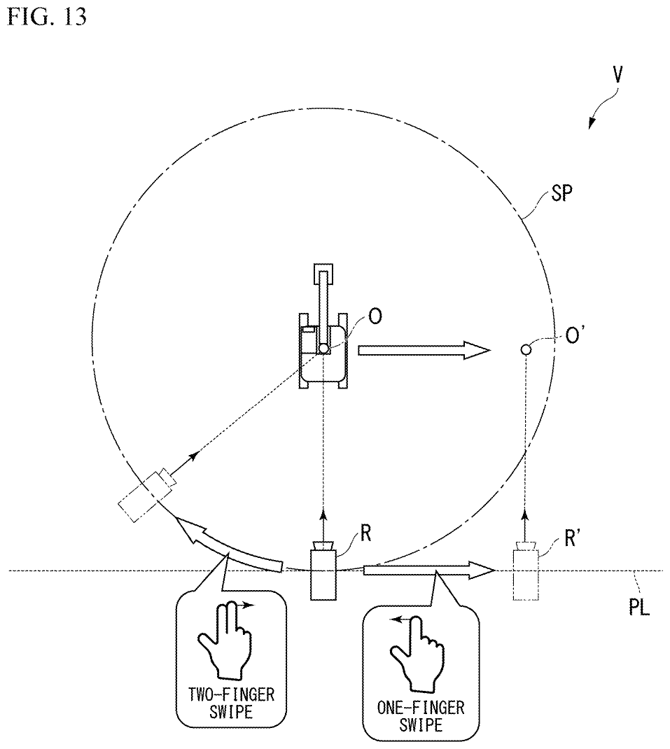

With reference to FIG. 13, a relationship between the touch operations of two-finger swipe and one-finger swipe with respect to the 3D screen G4 and a movement of a camera position in a three-dimensional space V will be described.

In a case where a touch operation of two-finger swipe is received in the display region of the 3D screen G4, the control unit 202 moves the camera position in the three-dimensional space V along a spherical surface SP centered on a predetermined center position O such that a direction of a camera R that projects a three-dimensional image always faces the center position O. Accordingly, the operator can change a viewing angle as desired while perceiving the center position O at the center of the screen.

In a case where a touch operation of one-finger swipe is received in the display region of the 3D screen G4, the control unit 202 moves the camera position in the three-dimensional space V along a plane PL without changing the direction of the camera R. With this arrangement, an area to be displayed in the three-dimensional space V can be changed as desired. Furthermore, in this case, along with the movement of the camera position from R to R′, the position of the center position also translates from 0 to 0′.

Furthermore, the example shown in FIG. 13 shows an example in which the camera position moves in a horizontal direction in the three-dimensional space V as a result of the operator swiping the monitor 22 in a lateral direction during both the touch operation of one-finger swipe and the touch operation of two-finger swipe. However, in a case where the operator swipes in a longitudinal or diagonal direction of the monitor 22, the camera position also moves in a height direction in the three-dimensional space V regardless of the touch operation of one-finger swipe or the touch operation of two-finger swipe.

(Other Display Screens)

Furthermore, regardless of receiving any of the foregoing touch operations (a) to (e) in the display region of the guidance image G0, the control unit 202 does not perform control according to the touch operation. Further, regardless of receiving any of the foregoing touch operations (a) to (e), the control unit 202 does not perform control according to the touch operation, for example, in a region where an icon, a pop-up menu window, or the like is displayed, in addition to the guidance image G0.

Furthermore, in order to implement the above control, step S05 in FIG. 4 may be executed in more detail as follows.

That is, in a case where the touch operation by the operator is received (step S04; YES), the display screen identification unit 203 first determines whether the position on the monitor 22 that has received the touch operation is a display region that does not belong to any of the above (1) to (4). In a case of a display region that does not belong to any of the above (1) to (4), that is, a display region such as the guidance image G0, the icon, and the menu window, the control unit 202 ends the process without performing any particular control. That is, the control unit 202 does not perform control according to the received touch operation. On the other hand, the display screen identification unit 203 identifies the type of the display screen in a case where the position on the monitor 22 that has received the touch operation is a display region that belongs to any of the above (1) to (4).

With this arrangement, in a case where the operator makes a touch operation with the intention of inputting to the guidance image G0 or the menu window, the touch operation can be prevented from being mistakenly recognized as any of the operations (a) to (e) with respect to each of the display screens (1) to (4).

Furthermore, regarding the enlargement and reduction of each display screen, in addition to the pinch-in and pinch-out operations, a dedicated button superimposed and displayed on each display screen may be touch-operated. For example, the control device 2 may perform the enlargement and reduction of the display screen by receiving the touch operations of “+” and “−” buttons superimposed and displayed on each display screen of FIGS. 5 to 12.

Furthermore, images displayed on the monitor 22 are not limited to aspects shown in FIGS. 5 to 12, and may be displayed in various screen configurations. For example, each of the images shown in FIGS. 5 to 12 divides one screen into three parts to include any three of the side view G1, the top view G2, the front image G3, and the 3D screen G4, but is not limited thereto in other embodiments. For example, the control device 2 according to other embodiments may have an aspect in which one screen is divided into two parts to include any two of the side view G1, the top view G2, the front image G3, and the 3D screen G4. Further, the control device 2 according to other embodiments may have an aspect that includes any one of the side view G1, the top view G2, the front image G3, and the 3D screen G4 without dividing one screen. Further, the number of such screen divisions and the type of display screen to be displayed in each divided display region may be freely customized by the operator.

In the above-described embodiment, the monitor 22 and the touch sensor 23 have been described as an aspect that is a so-called tablet-type terminal device integrally formed with a housing of the control device 2, but are not limited to this aspect in other embodiments.

The control device 2 according to other embodiments may not include the monitor 22, and may transmit a signal to display a display image on a monitor that is separate from the control device 2. Similarly, the control device 2 according to other embodiments may not include the touch sensor, 23 and may receive a signal related to the touch operation from a touch sensor that is separate from the control device 2.

Further, the control device 2 according to the other embodiment may be implemented from a system configured with a monitor and a touch sensor that are separate from the control device 2, and two or more control devices including each part of the configuration of the control device 2 according to the first embodiment.

Procedures of the above-described various processes in the control device 2 are stored on a computer-readable recording medium in the form of a program, and a computer reads and executes the program so as to perform the various processes. In addition, the computer-readable recording medium refers to a magnetic disk, a magneto-optical disk, a CD-ROM, a DVD-ROM, a semiconductor memory or the like. Further, this computer program may be distributed to a computer through a communication line, and the computer receiving the distribution may execute the program.

The above program may implement some of the above-described functions. Moreover, the program may also be a so-called difference file, a difference program or the like capable of implementing the above-described functions through a combination with a program that is already recorded in a computer system.

As described above, several embodiments of the present disclosure have been described, but the embodiments are presented as only examples, and thus are not intended to limit the scope of the invention. The embodiments can be implemented in other various forms, and various omissions, replacements, and changes can be made without departing from the gist of the invention. The embodiments or modifications thereof are included in the scope and the gist of the invention and also included in the invention disclosed in the claims and the equivalent scope thereof.

In the above-described embodiment, the work machine 1 has been described as a hydraulic excavator, but in other embodiments, it can be applied to various work machines such as a dump truck, a wheel loader, and a bulldozer.

Further, in the above-described embodiment, it has been described that one control device 2 is provided in the work machine 1, but in other embodiments, part of the configuration of the control device 2 may be disposed in another control device so as to be implemented by a control system configured with two or more control devices. Furthermore, the control device 2 according to the foregoing embodiment is also an example of the control system.

Further, the control device 2 according to the foregoing embodiment has been described as being provided in the work machine, but in other embodiments, part or all of the configuration of the control device 2 may be provided outside the work machine.

Further, in the above-described embodiment, a monitor has been described as being provided in the work machine, but in other embodiments, the monitor may be provided outside the work machine. For example, the monitor may be provided at a point away from a work site, and the control device 2 may transmit a signal that displays a display screen on the monitor via a network, such as the Internet or wireless communication.

According to the disclosure of the present invention, the operability of a control device can be improved.

1. A control device of a touch panel monitor for a work machine, the control device comprising:
a display signal generation unit configured to generate a display signal for displaying on the touch panel monitor including a plurality of display screens;
a determination unit configured to receive a touch operation for each of the plurality of display screens and determine whether the received touch operation is an acceptable touch operation defined for each type of the display screens; and
a control unit configured to perform a control with respect to the type of display screen according to the received touch operation when the received touch operation is the acceptable touch operation.

2. The control device according to claim 1, wherein
the acceptable touch operation in a top view, which is one of the types of display screens, includes at least a rotation operation.

3. The control device according to claim 2, wherein
the control unit rotates the top view around a center of a vehicle body when the rotation operation is received on the display screen of the top view.

4. The control device according to claim 2, wherein
the acceptable touch operation on a 3D screen, which is one of the types of display screens, includes a swipe operation based on at least two touch points.

5. The control device according to claim 4, wherein
the control unit rotationally moves a camera position in a three-dimensional space about a predetermined point when the swipe operation based on the least two touch points is received on the display screen of the 3D screen.

6. The control device according to claim 1, wherein
the control unit simultaneously performs the control with respect to each of the display screens that have received the touch operations according to each touch operation when touch operations are simultaneously received on each of the plurality of display screens.

7. The control device according to claim 1, wherein
the control unit prohibits the control according to the touch operation in a region where a predetermined display screen is displayed.

8. A work machine comprising the control device according to claim 1.

9. A control method of a touch panel monitor for a work machine, the control method comprising the steps of:
generating a display signal for displaying on the touch panel monitor including a plurality of display screens;
receiving a touch operation for each of the plurality of display screens, and determining whether the received touch operation is an acceptable touch operation defined for each type of the display screens; and
performing g control with respect to the display screen according to the received touch operation when the received touch operation is the acceptable touch operation.

10. The control device according to claim 3, wherein
the acceptable touch operation on a 3D screen, which is one of the types of display screens, includes a swipe operation based on at least two touch points.

11. The control device according to claim 10, wherein
the control unit rotationally moves a camera position in a three-dimensional space about a predetermined point when the swipe operation based on the at least two touch points is received on the display screen of the 3D screen.

12. The control device according to claim 11, wherein
the control unit simultaneously performs the control with respect to each of the display screens that have received the touch operations according to each touch operation when touch operations are simultaneously received on each of the plurality of display screens.

13. The control device according to claim 12, wherein
the control unit prohibits the control according to the touch operation in a region where a predetermined display screen is displayed.

14. A work machine comprising the control device according to claim 13.
